(19) United States
(12) Patent Application Publication
(10) Pub. No.: US 2005/0125786 A1
(43) Pub. Date: Jun. 9, 2005

(54) Compiler with two phase bi-directional scheduling framework for pipelined processors

(76) Inventors: Jinquan Dai, Shanghai (CN); Cotton Seed, Cambridge, MA (US); Bo Huang, Shanghai (CN); Luddy Harrison, Chestnut, MA (US)

Correspondence Address: James H. Salter;BLAKELY, SOKOLOFF, TAYLOR & ZAFMAN LLP, Seventh Floor, 12400 Wilshire Boulevard, Los Angeles, CA, 90025, US

(21) Appl. No.: 10/731,946

(22) Filed: Dec. 9, 2003

(51) Int. Cl. G06F 9/45

(52) U.S. Cl. 717/161

(57) ABSTRACT

A method of scheduling a sequence of instructions is described. A target program is read, a pipeline control hazard is identified within the sequence of instructions, and a selected sequence of instructions is re-ordered. Two steps for re-ordering are applied to the selected sequence of instructions. First, a backward scheduling method is performed, and second, a forward scheduling method is performed.

### FIELD OF THE INVENTION

The invention relates to improving the performance of operations executed by a pipelined processor. A compiler may identify a pipeline hazard and optimize the execution time of the target code to eliminate or reduce pipeline delays or “stalls” by rearranging the instructions.

### BACKGROUND

Pipelining is a technique in which multiple instructions are overlapped in execution, increasing the pipelined processor's performance. A disadvantage of pipeline architecture is the inability to continuously run the pipeline at full speed. Under certain conditions, pipeline hazards disrupt the instruction execution flow, and the pipeline stalls. An obvious trend is to adopting deeper pipelines, and so eliminating pipeline hazards becomes more critical to efficient operation of pipelined processors.

Pipeline hazards include:
1) structural hazards from hardware conflicts;
2) data hazards arising when an instruction depends on the result from a previous instruction;
3) control hazards from a branch, jump, and other control flow changes.

Pipeline hazards may reduce the overall performance of a processor by one third or one half.

A common example of a pipeline control hazard is a branch instruction, and a common solution is stalling the pipeline until the branch hazard is resolved. If the branch is not taken, execution of the program flow continues. If the branch is taken, fetching the next instruction is stalled until the hazard is resolved. The flow of the instructions that have already been loaded into the pipeline will be flushed. However, when the pipeline stalls, the efficiency of the processor decreases. Another approach is by using a branch prediction. However, this approach still has a negative impact on the processor efficiency if the branch prediction is wrong.

Another efficient solution to reducing pipeline inefficiencies is delayed branching (or delay slots), which is enabled by both software and hardware. The hardware exposes the delay slots to a compiler or user, and a compiler or user schedules it properly. Rather than allow the processor pipeline to stall, a code compiler may examine the program instructions, search for code that contains pipeline hazards and rearrange or add operations to the code sequence to avoid the hazard.

In delayed branching, if a branch is taken, the processor will still continue to fetch instructions after the branch. The solution to get the same behavior as a stalled pipeline is to insert No Operation (NOP) instructions after each branch. A better solution is to reduce or eliminate NOP delays by rearranging other instructions into the NOP cycles. Compilers may rearrange valid and useful instructions into the execution cycles of the delay slots instead of executing NOPs. However, current compilers that create branch delay slots, especially when the size of delay slots is variable, are marginally effective. In actual use the method is inefficient and generally, current compilers schedule the branch instruction after the other instructions, consequently not filling the delay slot effectively.

### BRIEF DESCRIPTION OF THE DRAWINGS

FIG. 1A is a block diagram of a computer system that may execute the invention.

FIG. 1B is a block diagram of a network environment coupled to a computer system enablement.

FIG. 2A illustrates a dependence Directed Acyclic Graph (DAG) with dependent latency of the example instruction sequence shown in FIG. 2B.

FIG. 2B illustrates an example code sequence and prior art forward scheduling method.

FIG. 2C illustrates an example code sequence and an embodiment of the invention first phase scheduling method.

FIG. 2D illustrates an inverse dependence Directed Acyclic Graph (DAG) with dependent latency and a tuple ordered pair used in an embodiment of the invention.

FIG. 2E illustrates an example code sequence, scheduled by a first phase operation, and an embodiment of the invention second phase scheduling method.

FIG. 3 illustrates a high level flow chart of the invention.

FIG. 4 illustrates a flow chart for one embodiment of a first phase scheduling method.

FIG. 5 illustrates a flow chart for one embodiment of a second phase re-scheduling method.

### DETAILED DESCRIPTION

There are different methods to overcome pipeline stall problems. Some methods are performed in the hardware design itself, but are expensive with regard to the resources required to implement a solution. Software solutions are easier to implement and usually operate by changing the order of the instructions in a program to eliminate a pipeline hazard stall.

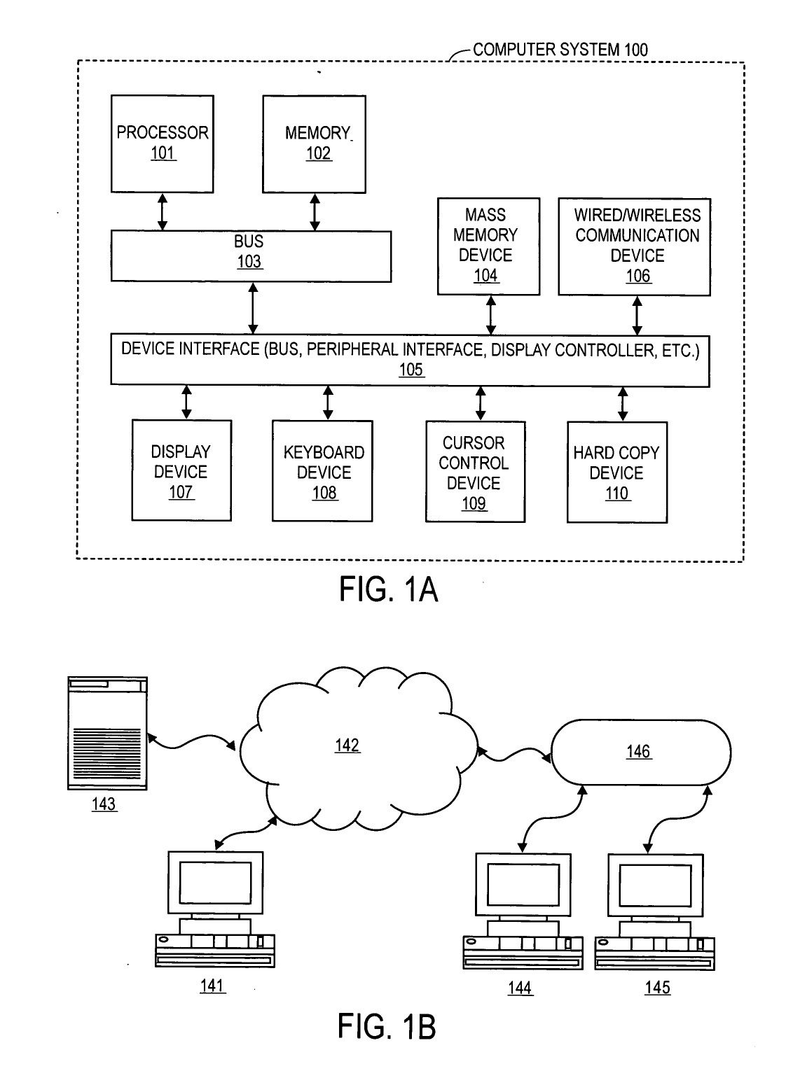

FIG. 1A illustrates a block diagram of a computer system 100 which may be used to execute an embodiment of the invention. Computer system 100 is comprised of processor 101 that may represent single or multiple processors, such as the Power PC™ processor (International Business Machines Corporation, Armonk, N.Y. 10504), the Pentium® processor (Intel Corporation®, Santa Clara, Calif. 95052) or other processors. Processor 101 is coupled with bus 103 to communicate information to other blocks or devices. Computer system 100 further comprises a memory 102 coupled to bus 103 for storing information and instructions to be executed by processor 101. Memory 102 also may be used for storing temporary variables or other intermediate information during execution of instructions by processor 101. Memory 102 may be a semiconductor dynamic random access memory (DRAM) and/or a static ram (SRAM) and/or a Read only Memory (ROM), etc. Bus 103 further couples the processor 101 to device interface 105.

Device interface 105, may include a display controller, and is coupled to the following devices 1) a mass memory device 104, which may be a hard drive, an optical drive such as a CD-ROM, etc., that retains stored data even when power is not applied to the mass memory device; 2) a Communication Device 106; 3) a display device 107, which may be a cathode ray tube (CRT) display, a liquid crystal display (LCD), or a plasma display, etc. for displaying information to a computer user; 4) a keyboard device 108 or other alphanumeric input device; 5) a cursor control device 109 such as a mouse, trackball, or other type of device for controlling cursor movement on display device 107; and 6) a hard copy device 110.

In addition, the invention may be stored on the mass memory device 104 with an operating system and other programs. For example, the computer system 100 may be a computer running a Macintosh operating system, a Windows operating system, a Unix operating system, etc. In one embodiment, the software used to facilitate the invention can be embodied onto a machine-readable medium. A machine-readable medium includes a mechanism that provides (e.g., stores and/or transmits) information in a form readable by a machine (e.g., a computer). Slower mediums could be cached to a faster, more practical, medium.

The communication device illustrated in FIG. 1A may interface Computer 100 to a variety of other external devices including networks, remote computers, phones, personal digital assistants, etc. FIG. 1B illustrates a network environment in which the present invention may operate. For example, the invention may access and operate on program instructions residing on a server connected to a network. In this conventional network diagram, server system 143 is coupled to a wide-area network 142. Wide-area network 142, also coupled to computer 141 and indirectly to computers 144 and 145, includes the Internet or other networks well known to those of ordinary skill in the art, who will recognize other networks, architectures, and topologies as being equivalent in operation. Server 143 may communicate through network 142 to a plurality of client computer systems 141, 144, and 145. For example, client 141 may be connected through network 142 to server 143, while clients 144 and 145 may be connected through network 142 to server 143 via local network 146. An embodiment may access a program file from server 143, operate on the file, and then send the result to computer system 144 for execution.

It will be appreciated that the description of computer system 100 represents only one example of a system, which may have many different configurations, architectures, and other circuitry that may be employed with the embodiments of the present invention. While some specific embodiments of the invention have been shown, the invention is not to be limited to these embodiments. For example, most functions performed by electronic hardware components may be duplicated by software emulation. Thus, a software program written to accomplish those same functions may emulate the functionality of the hardware components in input-output circuitry.

Described is a software solution to eliminate or reduce pipeline delays or “stalls” by rearranging the instructions. A branch instruction is an example of an instruction that may cause a stall. Usually, a control or data dependency exists between a branch instruction and another instruction.

Generally, a branch requires more than a single clock cycle to complete. A common solution for minimizing branch caused stalls in pipeline processors is a delayed branch or delay slot. The delay branch compensates for the delay required to load the program counter with the proper value during the branch operation. Many modern pipeline processors support delayed branches. For example, all the branch instructions in the MEv2 instruction set of the Intel® IXP2XXX (Intel Corporation®, Santa Clara, Calif. 95052) support both non-delayed and variable length delayed branch instructions. A prior art approach is to insert No-Operation (NOP) instructions after the branch to fill the branch delay. Unfortunately, when using NOPs, the overall efficiency and speed of a pipeline processor is reduced. Additionally, current compilers using basic block schedulers to overcome pipeline hazards such as a branch are not effective in scheduling for variable length delay slots.

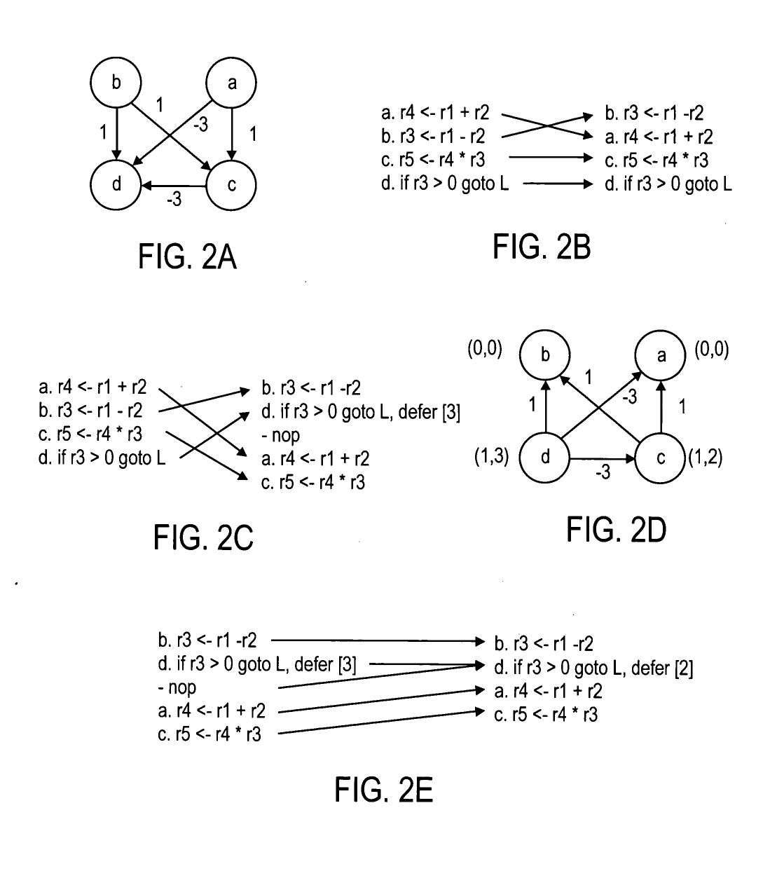

Compiler approaches may reorganize instructions. A compiler scheduler must search for a dependency on a branch and rearrange instructions so the register value that the branch uses will be stable and useable by the branch instruction. For example, current prior art compilers will usually perform forward scheduling which is illustrated in FIG. 2B. An example of an original code sequence is shown on the left in FIG. 2B. First, a block scheduler compiler will usually construct a dependence directed acyclic graph (“DAG”) of the original code sequence basic block showing the instruction dependence latency, as shown in FIG. 2A. A traverse forward method is then performed from the roots toward the leaves of the block selecting instructions to schedule. The dependent instruction is identified by the compiler and scheduled to reduce the risk of a pipeline hazard by moving the instruction to a position in the instruction list that precedes other instructions. The general purpose of these schedulers is to construct a topological arrangement of the dependence DAG while minimizing overall latency (or pipeline stall). In FIG. 2B, the original code sequence is shown to the left, and the re-ordered sequence is shown to the right. Instruction (b) has moved to the beginning of the block as the result of the compiler schedule. With the instruction in this order, the branch has a higher assurance of executing properly, with the correct value in dependent register 3. Unfortunately, when using this method, the branch instruction is always scheduled after all the other instructions, and consequently, delay slots are not likely to be filled.

In contrast, the current invention is able to aggressively fill a delay slot and also support variable delay slots. The invention may be embodied as incorporated into a program such as a compiler, assembler, linker, or may be embodied as a stand-alone program. A branch instruction delay slot is used as an example for the embodiment although other control instruction problems may also be addressed by the embodiments described.

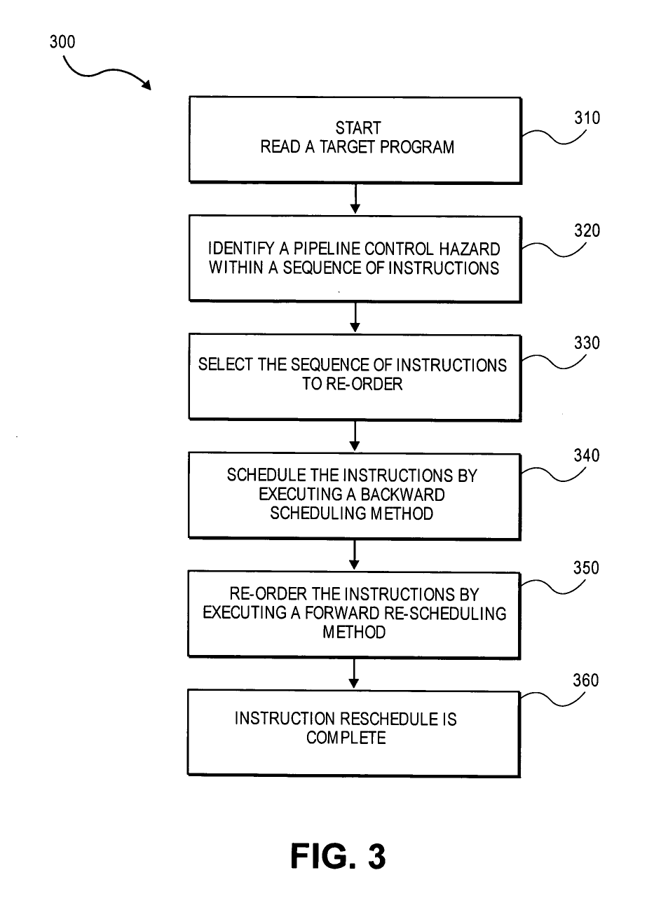

FIG. 3 illustrates one embodiment of the invention 300. Two operational phases 340 and 350 execute and rearrange the instructions. The first phase 340 executes a backward scheduling method and the second phase 350 executes a forward scheduling method. Using the two methods, 340 and 350 together, allows a more aggressive filling of the delay slot and consequently produces more efficient code. The method 310 reads a target sequence of program instructions from the target program. A pipeline control hazard or branch instruction is identified within the sequence of instructions 320. A sequence of instructions 330 is selected and subsequently, a block is defined. A backward scheduling method is then performed on the block 340 based on dependent latency and clock cycles. The dependent latency is analyzed based on the dependence DAG for the instruction list selected. The first phase 340 is performed using a backward scheduling method, followed by a forward re-scheduling method 350. The forward re-scheduling method is performed on the delay slot only, however, the forward method may also be performed on the entire block. The second phase 350 then efficiently packs the fixed or variable delay slot. When the instruction scheduling is complete at 360, the result of the rescheduling produces a sequence of instructions that operate more efficiently than the original sequence, and avoids a potential pipeline hazard. One embodiment is able to operate with both fixed and variable length delay slots. FIG. 2 illustrates examples of code sequences as operated on by prior art, and a first and second phase. A variable delay slot is illustrated in FIG. 2C, which illustrates the original code sequence and the result of the first phase schedule, and in FIG. 2E, which illustrates the result of the first phase and the result of the second phase re-schedule.

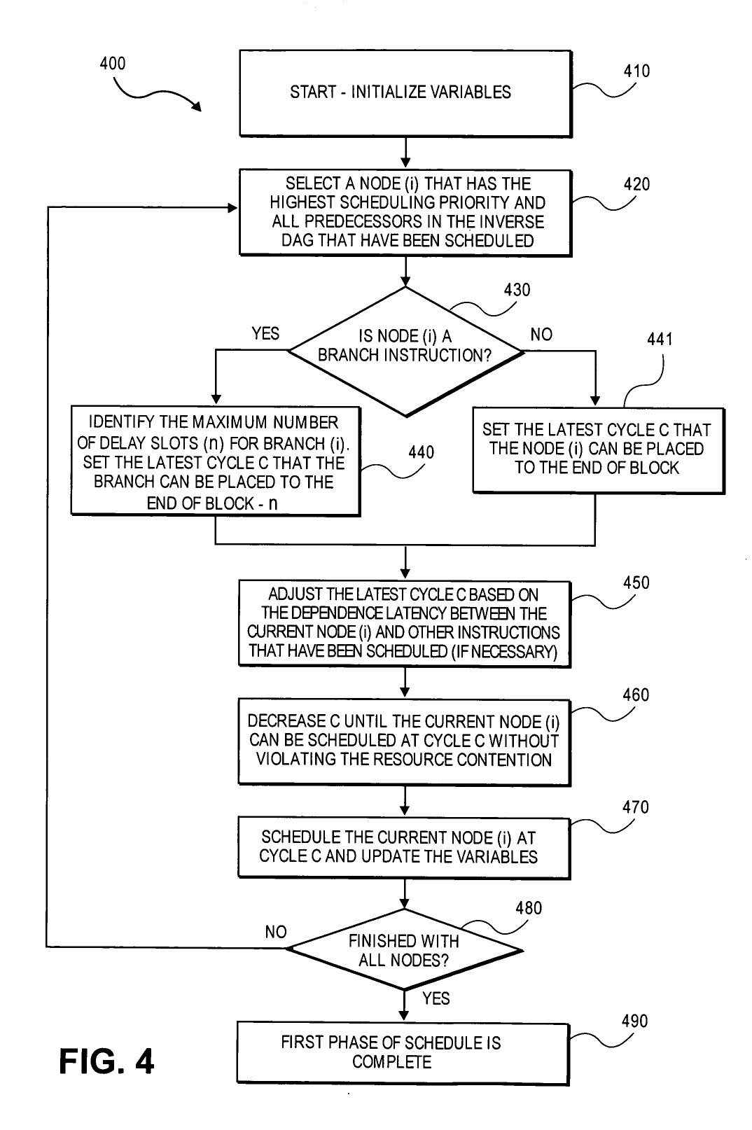

FIG. 4 illustrates further details of a first phase scheduling operation. One embodiment includes a first phase operation of a backward scheduling method. In the backward scheduling method, the delay slot is filled with instructions from before the branch. The dependence DAG is based on the latency of instructions as shown between the nodes in FIG. 2A. For example, the latency between instructions (c) and instruction (d) is minus 3, which means that instruction (c), although in its original order is executed before instruction (d), may be scheduled as late as 3 cycles after instruction (d). This allows instruction (c) to be placed in the delay slot of instruction (d). The first phase operates on the code sequence and rearranges the instructions as shown in FIG. 2C. FIG. 2C shows the original example code sequence on the left, and the resulting instruction arrangement after the first phase backward scheduling method is completed on the right.

In FIG. 4, scheduling method 400 begins by initializing variables 410. The first phase of the invention then traverses the dependence DAG backward (or traverses the inverse DAG forward). A branch instruction is identified, and its delay slot is set to its maximum length. A node is selected and scheduled according to its priority 420. In one embodiment, the scheduling priority is organized as an ordered tuple pair as shown in the inverse dependent DAG in FIG. 2D. FIG. 2D shows the inverse dependent DAG for the original code sequence illustrated in FIG. 2B. A tuple pair (c, n) is used where c is the length of the critical path of the node (or the longest path from the node to the leaves), and n is the number of immediate successor instructions. An instruction has priority based on (c1, n1) being greater than (c2, n2) if an only if (c1>c2) or if (c1==c2 and n1>n2).

Referring back in FIG. 4, when a branch instruction 430 is identified, the maximum number of delay slots for the branch is used to determine the size of the delay slot and the position of the branch instruction before the end of the block 440. For example, this operation is shown in FIG. 2C, scheduling the branch instruction from being the last instruction to a position from the end of the block equal to the maximum number of delay slots for the branch. For example, “defer [3]” provides a delay of three cycles to the end of block.

The next preceding instruction is examined, and if it is not a branch instruction 441, it is scheduled according to its dependence latency in comparison with instructions that have already been scheduled 450. The instruction position is also adjusted to avoid being scheduled where a prior scheduled instruction has positioned 460. The current instruction is then scheduled 470, and if all of the nodes within the block have been scheduled 480, the first phase of the method is complete 490. The final schedule for the code sequence example is shown in FIG. 2C. The first phase backward schedule method places the branch instruction further up the instruction list. Non-dependent instructions are scheduled after the branch instruction, and the delay slots of the branch instruction are filled with valid instructions.

I. The pseudo code representation of the software for computer implementation for the backward scheduling method is shown below:

```
    Construct an inverse dependence DAG, with each edge labeled
with the corresponding latency and each node labeled with its scheduling
priority.
    Set the status of roots in the inverse dependence DAG to ready,
and the other nodes to unready.
    Set the resource table for the basic block to empty.
    While (there is a node whose status is ready)
    {
    Select a node i that has the highest scheduling priority and
whose status is ready (if there is more than one such node,
randomly select one).
    C = EoB (the cycle located at the bottom of the basic block;
i.e., start of successor blocks);
    If (i is a branch with maximum length of delay slots to be n)
        C = C − n;
    For (each instruction j that depends on i in the original sense,
i.e., j is a predecessor of i in the inversed dependence DAG, with
the corresponding latency to be s)
    {
        If (j is in the same basic block as i; i.e., j is the
    predecessor of i in the inverse dependence DAG)
        {
            t = the cycle that j is scheduled at;
            m = t − s;
        }
        Else
        {
            t = number of cycled from j to the bottom of the
        basic block;
            m = EoB + t − s;
        }If (m < C)
            C = m
    }While (i cannot be scheduled at cycle C due to resource
contention constraints)
        C = C−1;
    Schedule i at cycle C, add its resource usage to the resource
table, and change its status to done.
    For (each immediate successor node j of i in the inverse
dependence DAG whose status is unready)
    {
        If (none of the immediate predecessor nodes of j in the
    inverse dependence has unready status)
            Change the status of j to ready.
    }
}
```

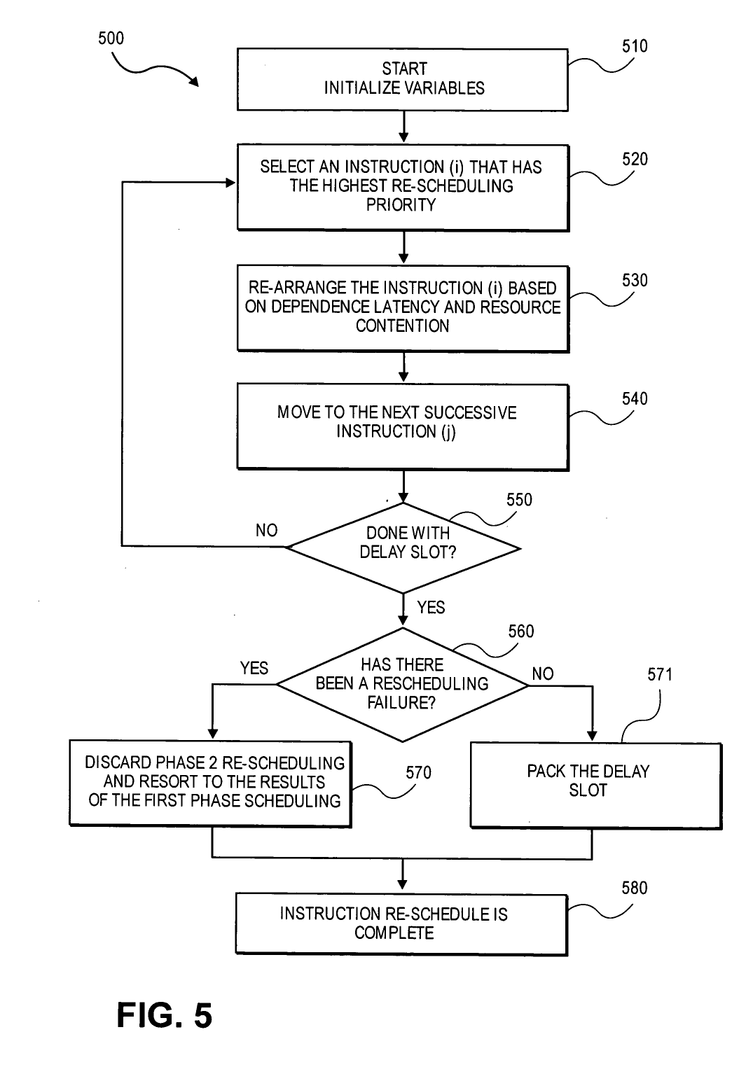

FIG. 5 illustrates further details of a second phase re-scheduling operation 500. Since the block size is based on the maximum length of the branch delay slot, a No-Operation instruction (NOP) is placed into each open cycle during the first phase. An example is shown by FIGS. 2C and 2E after execution of the first phase. When the first phase backward scheduling method is complete, a second forward re-scheduling method is performed as shown in FIG. 2E and FIG. 5. In FIG. 2E, the instruction order, after the first phase is complete, is shown on the left. The result of the phase two forward re-scheduling method is shown re-ordered to the right. Generally, the second phase of the scheduler examines the instruction list and re-schedules instructions within the delay slot. However, the second phase is capable of also operating on the entire block.

Referring again to FIG. 5, after the variables have been initialized 510, an instruction is selected either from the delay slot or the block based on its priority 520; (i.e., the priority is where the instruction was scheduled by phase one). The instructions are then rearranged based on the latency of the instruction and resource constraints 530. The next successive instruction is then operated on in the same manner as described above 540, and the remainder of the delay slot is checked to verify that the re-arrangement is complete 550. For example, during this portion of the second phase operation, instructions (a) and (c) as shown in FIG. 2E have been arranged to the top of the delay slot. The instructions (a) and (c) have replaced the NOP and the delay block in instruction (d) has gone from three to two cycles. If NOP instructions are at the end of the delay slots, the end of block is moved forward and any NOPs are eliminated. As a result, the NOP has been eliminated and valid instructions now fill the delay slot.

In the above process of rescheduling, there may be only a finite range of valid cycles to reorder an instruction into. Therefore the rescheduling during the second phase may fail. In order to make such a failure infrequent, the second phase reschedules those instructions in the order of the scheduled cycles after the first phase. In addition, the second phase will identify whether or not there has been a rescheduling failure 560. If rescheduling of any instruction fails, the second phase scheduler will detect the failure and resort to the resulting first phase instruction list 570. If a rescheduling failure has not occurred, the delay slots are packed, and the NOPs are eliminated by moving the bottom of the block 571 forward to contain only valid instructions. FIG. 2E shows the result of a second phase operation; the NOP has been eliminated, and the variable delay “defer [x]” has been reduced to two cycles from three cycles. The second phase forward scheduling is then complete 580.

II. The pseudo code representation of the software for computer implementation for the forward re-scheduling method is shown below:

```
For (each instruction in the delay slots)
{
    Remove its resource usage from the resource table.
    Set its status to re-scheduling.
    Set its re-scheduling priority to its scheduled cycle in the first phase
(the smaller the cycle is, the higher the re-scheduling priority is).
}
While (there is an instruction whose status is re-scheduling)
{
    Select an instruction i that has the highest re-scheduling priority
and whose status is re-scheduling (if there is more than one such
instruction, randomly select one).
    S = SoB (the start cycle of the block as in the result of the first
phase);
    For (each immediate successor j of i in the inverse dependence
DAG, with the corresponding latency to be s)
    {
        If (The status of j is done or re-scheduled)
        {
            t = the cycle at which j is scheduled in the first phase (if
        its status is done), or at which j is re-scheduled in the second
        phase (if its status is re-scheduled);
            m = t + s;
            If (m > S)
                S = m;
        }
    }
    E = EoB;
    For (each immediate predecessor j of i in the inverse dependence
DAG, with the corresponding latency to be s)
    {
        If (The status of j is done or re-scheduled)
            {t = the cycle at which j is scheduled in the first phase (if
        its status is done), or at which j is re-scheduled in the second
        phase (if its status is re-scheduled);
            m = t − s;
            If (m < E)
                E = m;
        }
    }Rescheduled = false;
    For (each cycle C from S to E)
    {
        If (i can be scheduled at cycle C)
              {Re-schedule i at cycle C, add its resource usage to
              the resource table, and change its status to re-
              scheduled.
              Re-scheduled = true;
              Break.
        }
    }
    If (Re-scheduled == false)
        Use the result of first phase and return.
}
E1 = the cycle that the branch instruction is scheduled at;
E2 = E1 + the maximum length of the delay slots of the
branch instruction;
For (each cycle C from E1 to E2)
{
    If (the bottom of the basic block, i.e., beginning of successor
blocks, can be scheduled at cycle C)
            Place the bottom of the basic block at cycle C and return.
}
Use the result of the first phase.
```

The two phase bi-directional scheduling framework result as described above results in the most aggressive filling of a delay slot and more efficient code has been produced in comparison to the original code. The operation of both a backward scheduling system and forward scheduling system results in a packed instruction block, eliminating unnecessary NOPs, and also supports variable length delay slot.

1. A method of scheduling a sequence of instructions, comprising:
reading a target program;
identifying a pipeline control hazard in the sequence of instructions;
selecting the sequence of instructions to re-order;
re-ordering the sequence of instructions by executing a backward scheduling method; and
re-ordering the sequence of instructions by executing a forward scheduling method.

2. The method as recited in claim 1, wherein the pipeline control hazard is a branch instruction.

3. The method of claim 1, further comprising:
performing the backward scheduling method prior to performing the forward scheduling method.

4. The method of claim 1 wherein the forward scheduling method reorders at least one instruction within a delay slot.

5. The method of claim 1, further comprising:
evaluating the forward scheduling method for a schedule failure; and
using the backward scheduling method result when the forward schedule method encounters the schedule failure.

6. The method of claim 3, further comprising:
packing the delay slot subsequent to executing the forward scheduling method.

7. The method of claim 4 wherein the delay branch is a fixed length.

8. The method of claim 4 wherein the delay branch is a variable length.

9. A machine readable medium having stored therein instructions for use in a machine, the instructions comprising:
instructions to schedule a sequence of instructions;
instructions to read a target program;
instructions to identifying a pipeline control hazard in the sequence of instructions;
instructions to select the sequence of instructions to re-order;
instructions to re-order the sequence of instructions by executing a backward scheduling method; and
instructions to re-order the sequence of instructions by executing a forward scheduling method.

10. A machine readable medium as claimed in claim 9, wherein the pipeline control hazard is a branch instruction.

11. A machine readable medium as claimed in claim 9, further comprising:
instructions to perform a backward scheduling method prior to performing the forward scheduling method.

12. A machine readable medium as claimed in claim 9, wherein the forward scheduling method reorders at least one instruction within a delay slot.

13. A machine readable medium as claimed in claim 9, further comprising:
instructions to evaluate the forward scheduling method for a schedule failure; and
instructions to use the backward scheduling method result when the forward schedule method encounters the schedule failure.

14. A machine readable medium as claimed in claim 9, further comprising:
instructions to pack the delay slot subsequent to executing the forward scheduling method.

15. A machine readable medium as claimed in claim 9, wherein the delay branch is a fixed length.

16. A machine readable medium as claimed in claim 9, wherein the delay branch is a variable length.

17. A system comprising:
one or more processors; and
a memory coupled to the one or more processors, the memory having stored therein a program code which, when executed by the one or more processors, causes the one or more processors to:
read a target program;
identify a pipeline control hazard in a sequence of instructions;
select the sequence of instructions to re-order;
re-order the sequence of instructions by executing a backward scheduling method; and
re-order the sequence of instructions by executing a forward scheduling method.

18. The system as claimed in claim 17, wherein the system is a computer system.

19. The system as claimed in claim 17 further comprises a display device.

20. The system as claimed in claim 17, wherein the pipeline control hazard is a branch instruction.

21. The system as claimed in claim 17, further comprising:
performing the backward scheduling method prior to performing the forward scheduling method.

22. The system as claimed in claim 17 wherein the forward scheduling method reorders at least one instruction within a delay slot.

23. The system as claimed in claim 17, further comprising:
evaluating the forward scheduling method for a schedule failure; and
using the backward scheduling method result when the forward schedule method encounters the schedule failure.

24. The system as claimed in claim 21, further comprising:
packing the delay slot subsequent to executing the forward scheduling method.

25. The system as claimed in claim 22 wherein the delay branch is a fixed length.

26. The system as claimed in claim 22 wherein the delay branch is a variable length.
